(19) United States
(12) Patent Application Publication
(10) Pub. No.: US 2011/0050420 A1
(43) Pub. Date: Mar. 3, 2011

(54) ELECTRONIC APPARATUS WITH ALARM FUNCTION AND METHOD THEREOF

(75) Inventor: PENG LI, Beijing (CN)

(73) Assignees: HONG FU JIN PRECISION INDUSTRY (ShenZhen) CO., LTD, Shenzhen City (TW); HON HAI PRECISION INDUSTRY CO., LTD., Tu-Cheng (TW)

(21) Appl. No.: 12/606,122

(22) Filed: Oct. 26, 2009

(30) Foreign Application Priority Data
Aug. 31, 2009 (CN) 200910306329.X

(51) Int. Cl. G08B 13/14

(52) U.S. Cl. 340/568.1; 382/190

(57) ABSTRACT

An electronic apparatus with an alarm function is provided. The electronic apparatus includes an image obtaining device, a data storage, and a processing unit. The image obtaining device is for obtaining an image of the position where the electronic apparatus is located. The data storage is for storing at least one predetermined alarm signal. The processing unit controls the image obtaining device to obtain the image of the position where the electronic apparatus is located; stores the obtained image to the data storage; compares a currently obtained image with a previously obtained image to determine whether the currently obtained image is the same as the previously obtained image; accessing one predetermined alarm signal from the data storage if the currently obtained image is not the same as the previously obtained image, and outputting the predetermined alarm signal through the audio output unit.

### BACKGROUND

1. Technical Field

The present disclosure relates to an electronic apparatus with an alarm function and a method thereof.

2. Description of Related Art

Generally, when engaging in sports activities, people often put their portable electronic devices (e.g. mobile phones, MP3, etc) aside to avoid potential damages to the electronic devices. However, during sports, they usually cannot pay close attentions to their electronic devices, as a result, the electronic devices may easily be stolen.

### BRIEF DESCRIPTION OF THE DRAWINGS

The components of the drawings are not necessarily drawn to scale, the emphasis instead being placed upon clearly illustrating the principles of the electronic apparatus with an alarm function. Moreover, in the drawings, like reference numerals designate corresponding parts throughout several views.

FIG. 1 is a block diagram of an electronic apparatus 1 with an alarm function in accordance with an exemplary embodiment.

FIG. 2 is a flowchart of an alarm method applied on the electronic apparatus of FIG. 1 in accordance with an exemplary embodiment.

### DETAILED DESCRIPTION

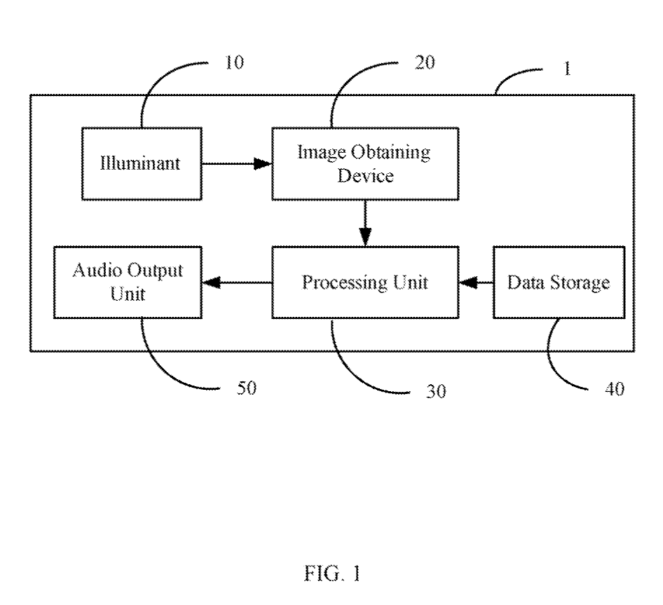

FIG. 1 is a block diagram of an electronic apparatus 1 with an alarm function (hereinafter “the apparatus”) in accordance with an exemplary embodiment. The alarm function of the electronic apparatus 1 is activated to prompt its owner when the electronic apparatus 1, which is away from the owner, is taken away. The electronic apparatus 1 includes an image obtaining device 20, a processing unit 30, a data storage 40, and an audio output unit 50. The image obtaining device 20 is placed on an appropriate position of the electronic apparatus 1, such as a front side or a back side thereof, for obtaining an image of the location where the electronic apparatus 1 is placed at.

After the alarm function of the electronic apparatus 1 is activated, the processing unit 30 controls the image obtaining device 20 to periodically obtain the image of the location where the electronic apparatus 1 is placed at and sends the obtained image to the data storage 40. The processing unit 30 compares a currently obtained image, which obtained by the image obtained device 20 currently, with a previously obtained image, which obtained by the image obtained device 20 previously, to determine whether the currently obtained image is the same as the previously obtained image. In this exemplary embodiment, the processing unit 30 compares pixel values of the current obtained image with that of the previously obtained image to determine whether the currently obtained image is the same as the previously obtained image. If the current obtained image is not the same as the previously obtained image, the processing unit 30 accesses a predetermined alarm signal (e.g. sounds) from the data storage 40, and outputs the predetermined alarm signal through the audio output unit 50.

In another exemplary embodiment, the electronic apparatus 1 further includes an illuminant 10. The illuminant 10 is positioned in the same side as the image obtaining device 20. When the electronic apparatus 1 is placed on a surface of an object, the illuminant 10 spots a bright spot on the surface of the object. The image of the location is the image of the bright spot. Attributes of the bright spot, such as the size or the luminance of the bright spot, can be taken as a reference spot to determine whether the currently obtained image is the same as the previously obtained image.

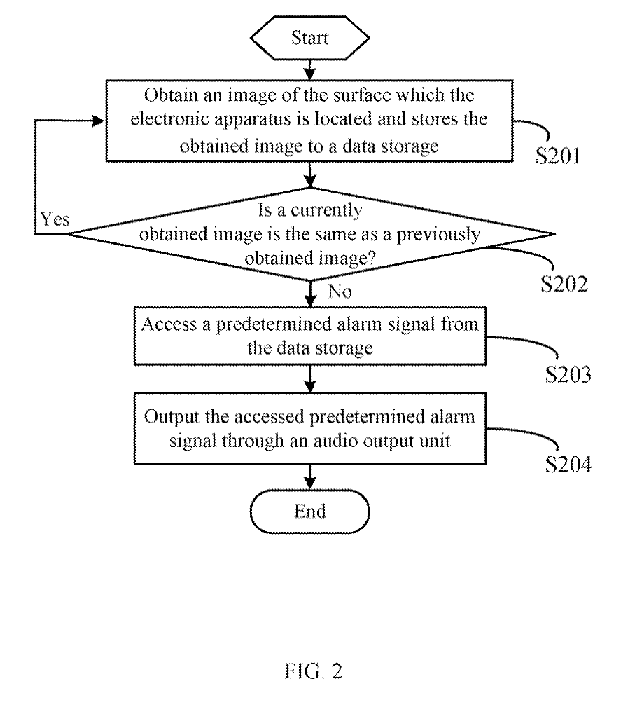

FIG. 2 is a flowchart of an alarm method applied on the electronic apparatus 1 of FIG. 1.

In step S201, the processing unit 30 controls the image obtaining device 20 to periodically obtain the image of the location where the electronic apparatus 1 is placed at and stores the obtained image to the data storage 40.

In step S202, the processing unit 30 compares the currently obtained image with the previously obtained image to determine whether the currently obtained image is the same as the previously obtained image

In step S203, if the current obtained image is not the same as the previously obtained image, the processing unit 30 accesses a predetermined alarm signal from the data storage 40.

In step S204, the processing unit 30 outputs the accessed predetermined alarm signal through the audio output unit 50.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic apparatus with an alarm function, comprising:
an image obtaining device for obtaining an image of the location where the electronic apparatus is placed at;
a data storage for storing at least one predetermined alarm signal; and
a processing unit for controlling the image obtaining device to periodically obtain the image of the location where the electronic apparatus is placed at; storing the obtained image to the data storage; comparing a currently obtained image, which the image obtained device obtained currently, with a previously obtained image, which the image obtained device previously, to determine whether the currently obtained image is the same as the previously obtained image; accessing one predetermined alarm signal from the data storage if the currently obtained image is not the same as the previously obtained image, and outputting the predetermined alarm signal through the audio output unit.

2. The electronic apparatus as described in claim 1, wherein the processing unit compares pixel values of the current obtained image with that of the previously obtained image to determine whether the currently obtained image is the same as the previously obtained image.

3. The electronic apparatus as described in claim 1, further comprising an illuminant, wherein the illuminant is positioned in the same side as the image obtaining device, when the electronic apparatus is placed on a surface of an object, the illuminant spots a bright spot on the surface of the object, the image of the location being the image of the bright spot, the processing unit compares a size or illuminant of the bright spot of the current obtained image with that of the previously obtained image of the bright spot to determine whether the currently obtained image is the same as the previously obtained image.

4. An alarm method applied on an electronic apparatus, comprising:
providing an image obtaining device and a data storage for the electronic apparatus, the image obtaining device for obtaining an image of the location where the electronic apparatus is placed at, and the data storage for storing at least one predetermined alarm signal;
controlling the image obtaining device to periodically obtain the image of the location where the electronic apparatus is placed at;
storing the obtained image to the data storage;
comparing a currently obtained image with a previously obtained image to determine whether the currently obtained image is the same as the previously obtained image;
accessing one predetermined alarm signal from the data storage if the currently obtained image is not the same as the previously obtained image; and
outputting the predetermined alarm signal through an audio output unit.

5. The method as described in claim 4, wherein determining whether the currently obtained image is the same as the previously obtained image is by comparing whether the pixel value of the currently obtained image is the same as that of the previously obtained image.

6. The method as described in claim 1, wherein the step of obtaining the image of location further comprises providing an illuminant for the electronic apparatus, wherein the illuminant is positioned in the same side as the image obtaining device, when the electronic apparatus is placed on a surface of an object, the illuminant spots a bright spot on the surface of the object, determining whether the current obtained image is the same as the previously obtained image by comparing a size or illuminant of the bright spot of the currently obtained image with that of the previously obtained image
